(19) United States
(12) Patent Application Publication
(10) Pub. No.: US 2017/0035037 A1
(43) Pub. Date: Feb. 9, 2017

(54) Clear planer board

(71) Applicant: BJ Ayers, JR., Fancy Gap, VA (US)

(72) Inventor: BJ Ayers, JR., Fancy Gap, VA (US)

(21) Appl. No.: 14/999,337

(22) Filed: Apr. 25, 2016

Related U.S. Application Data
(60) Provisional application No. 62/282,647, filed on Aug. 5, 2015.

(51) Int. Cl. A01K 91/08

(52) U.S. Cl. CPC A01K 91/08

(57) ABSTRACT

A planer board having a transparent main body and a floatation device attached to an upper end of the transparent main body. The planer board is adapted to be connected to a fishing line that is disposed between a lure and a fishing pole on a moving boat. The planer board is capable of carrying the fishing lure laterally away from the moving boat and being essentially invisible to fish.

This application claims priority from U.S. Provisional Ser. No. 62/282,647 filed Aug. 5, 2015.

### BACKGROUND OF THE INVENTION

The present invention relates to portable outrigger boards, namely planer boards used for sport fishing. Planer boards carry fishing lures outwards laterally away from a moving boat hull. As shown in FIG. 1, planer boards P help fishermen cover more area and reach places they would not have been able to reach by regular fishing methods. Planer boards are especially effective for trolling. A lure C is attached to a fishing line L at the end of a fishing rod R. The fishing line L is attached to the planer board. The planer board P is connected to the boat V by a planer board line or by the fishing line L itself. As the planer board line or fishing line L is let out, the planer board P carries the fishing line L and lure C away from the boat V as shown in FIG. 1.

### SUMMARY OF THE INVENTION

The present invention is directed to a clear or transparent planer board.

### BRIEF DESCRIPTION OF THE FIGURES

FIG. 1 is an overhead view of planer boards being pulled by a boat;

FIG. 2 is a frontal view of the planer board of the invention;

FIG. 3 is a side view of the planer board of the invention;

FIG. 4A is a port side configurations of the planer board of the present invention;

FIG. 4B is a starboard side configurations of the planer board of the present invention;

FIG. 5 is a perspective view of a portside configuration of the planer board with lines connected thereto.

### DETAILED DESCRIPTION

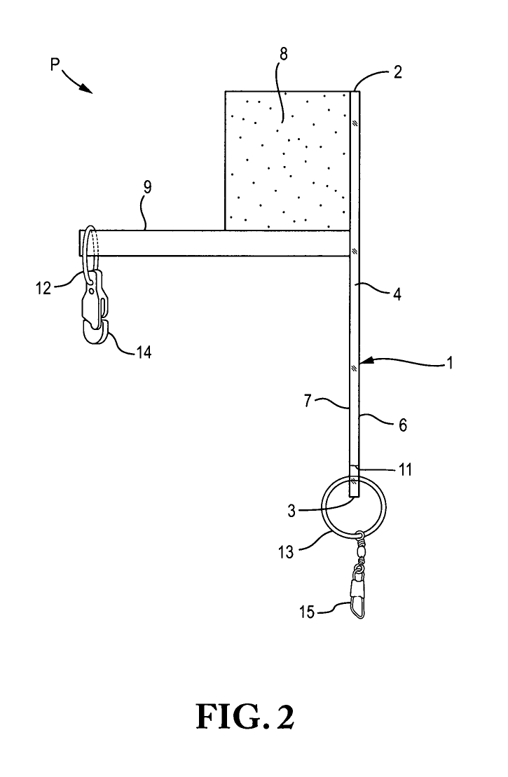

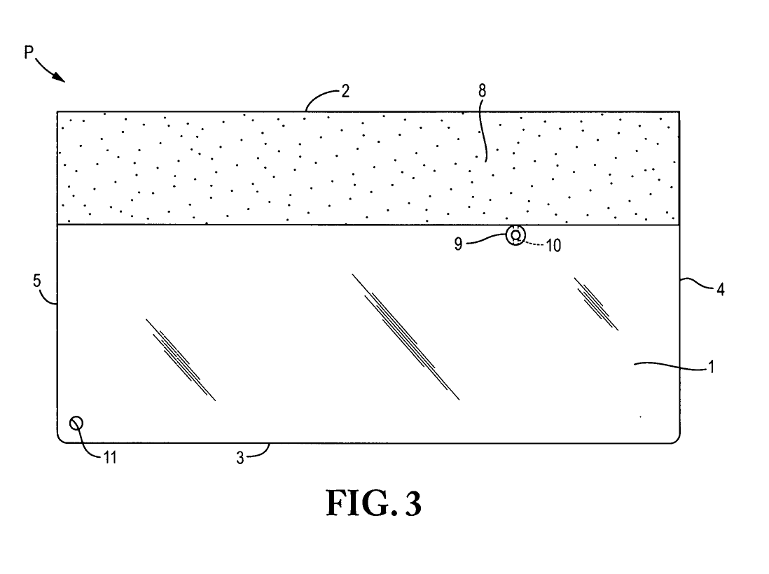

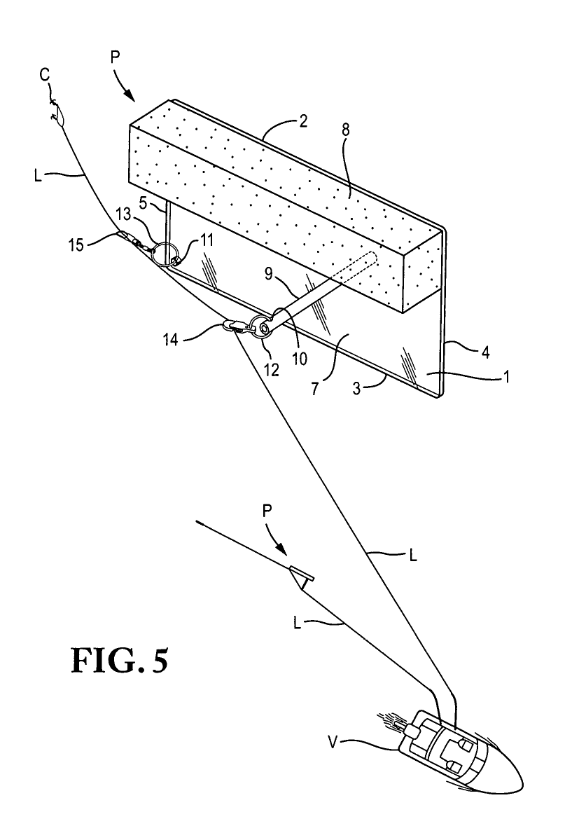

As shown in FIGS. 2 and 3, the main board 1 of the planer board P is made of a clear, colorless, transparent plastic or other transparent polymer material. Typical materials are acrylic, acrylic glass, plastic resin such as PETG (Polyethylene terephthalate), Lexan® or other transparent thermoplastic glass that is sturdy. The main board 1 is generally rectangular in shape with a top long horizontal end 2, a bottom long horizontal end 3 and two opposing shorter vertical ends 4 and 5. There is a forward vertical end 4 and rear vertical end 5. The main board 1 has a backside 6 and a front side 7. A floatation device 8 is attached to the top long horizontal end 2 on the front side 7 of the main board 1. A rod 9 is attached just below the floatation device 8 and protrudes perpendicularly away from the plane of the front side 7 of the main board 1 at about a 90-degree angle. The rod is situated closer to the front end of the board, about ¾ to about ⅔ of the distance from the rear end to the front end of the board. The rod 9 defines a hole 10 at an end of the rod opposite from where it is attached to the main board 1. The hole 10 accepts a ring 12 and/or release clip 14 for releasing the fishing line L (FIG. 5).

The planer board also defines a split ring hole 11 at a corner defined by the bottom horizontal end and a vertical rear end 5.

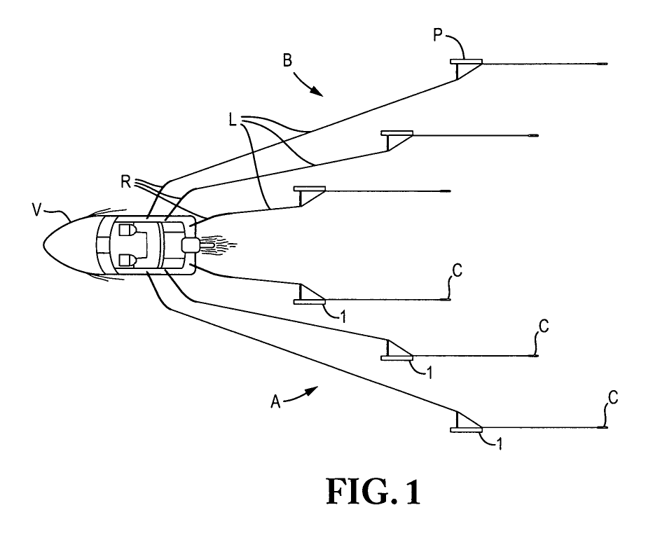

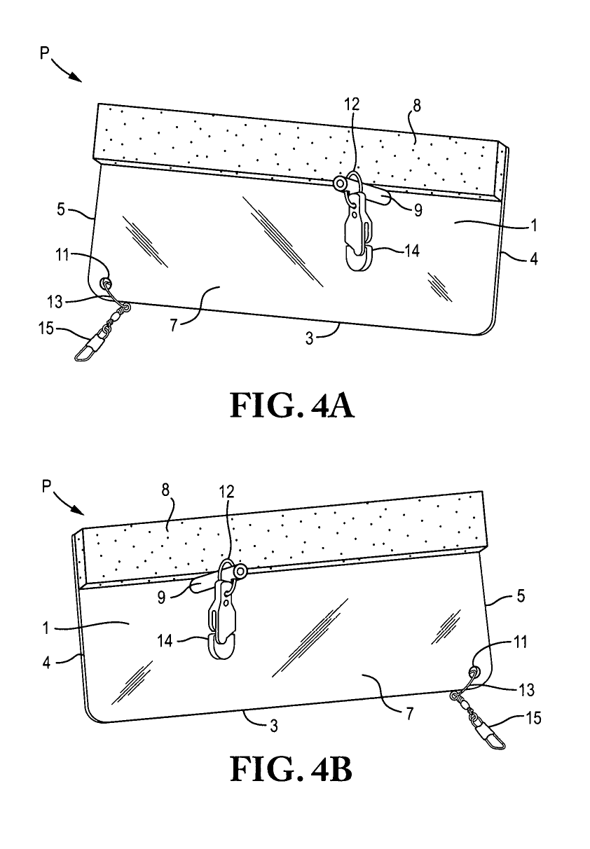

As shown in FIGS. 4A and 4B, planer boards are designed in two configurations depending on what side of the boat they will be used. One configuration is a port side board configuration FIG. 4A and the other configuration is a starboard side board configuration FIG. 4B. FIG. 1 also shows the port side configuration A and starboard side configuration B in use.

Planer boards can be configured in various sizes without taking away from the spirit of the invention. The type of fish, the type of lure and/or the water conditions determines the size of the board. The preferred sizes are 4½ inch×9 inch and 5½ inch×10½ inch. The smaller boards are better for smaller lures while the larger boards are better for larger lures. All sizes of boards are made with the same materials; the only difference is in the size dimensions of the foam and/or the board material.

The planer board is made of a laser machined cut piece of clear, colorless acrylic, acrylic glass, plastic resin such as PETG (Polyethylene terephthalate), Lexan® or other transparent thermoplastic glass that is invisible to fish and that is sturdy. Other rigid clear plastic materials may also be used. The board is typically run through a laser etcher, which rolls the edges of the board to make them smooth. A logo may be laser etched into the board. Two small holes are drilled into each board. The top hole is used to hold the aluminum rod 9. The bottom split ring hole 11 is used to hold the sub ring 13 for a swivel attachment 15 (FIG. 5).

It is important that the board be made of a clear material that is essentially invisible to a fish's vision. Translucent, semi-transparent or solid color materials are not effective for purposes of this invention as they would be visible to the fish.

The foam for floatation used in the board is a plank foam. This foam is a highly water resistant foam, which allows the board to be pulled through the water for long periods of time without gathering or becoming saturated with water. The foam retains its properties in hot and cold-water temperatures. The foam is also preferably mildew proof. Plank foam will not chip, dent or tear while being pulled through the water. The foam measures 1½ inch×1½×9 inches. The plank foam is attached to the board by double adhesive tape or glue. The tape or glue is waterproof and resists high and cold temperatures. Other attachment glues or fasteners may also be used. There are typically 2 strips of tape applied to each board to measure 1½ inches; this allows a total grip of the Plank Foam which also measures 1½ inches. Other types of floatation devices may be used that are cut or shaped to fit along the top long horizontal end 2 of the main board 1. The floatation devices must have sufficient floatation capability to prevent the planer board P from sinking, especially during use.

The rod 9 is preferably a hollow aluminum rod. More preferably the rod is a 2213 sized Easton® aluminum shaft. The length of the rod may vary based on the size of the board. For example, the length of the rod in the smaller board described above is 4½ inch and the larger board is 5½ inch. The rod is preferably 22/64 in diameter, with a wall thickness of 13 thousandths. The rod 9 may also be plastic or other light weight rigid material.

The rod may be connected to the board by any means. In one embodiment the rod connects to the board by having a 2213 aluminum insert glued into the front side 6. The size of the board generally determines the rod length. This insert is threaded. A stainless steel 8/32 buttonhead screw may be used to attach the rod to the board. Two Teflon washers may be used, one against the board, and one against the insert side. These washers help eliminate pressure to the board while being pulled at speeds up to 2 MPH. A hole 10, preferably ⅛ inch hole, is drilled on the other end of the rod through the entire diameter of the rod. This hole is used to hold the ring 12, which in turn holds the rod release clip 14. The release clip used are preferably offshore or Scotty® type releases clips. However, other release clips may also be used.

In use, a fish can see the fishing lure that travels behind the planer board but cannot see the planer board itself. The board is essentially invisible to the fish in the water. Because the board is invisible to the fish, the fish are not frightened or distracted by the planer board, which is an essentially large object compared to the lure. The fish can focus on striking the lure when there is no large object moving along with it. This provides a great advantage as fish are usually very timid of foreign objects.

The use of light weight foam for floatation and the use of clear, colorless acrylic, acrylic glass, plastic resin such as PETG (Polyethylene terephthalate), Lexan® or other transparent thermoplastic glass that is sturdy renders the board lightweight, typically less than 5 ounces. The board is usually 2.5 to 5 ounces. When a fish is caught, the angler will only expend energy reeling in the fish and minimum energy reeling in the planer board affixed to the fishing line. The lightweight material that the board is made with is less burdensome than wood. With traditional wooden planer boards, the angler fights the board weight and the fish, which can be tiring. With the planer board of the invention, the angler fights the fish and not the board.

In operation, the forward vertical end 4 leads in the water. Referring to FIG. 5, the configuration of the lines is shown. One end of a fishing line L is attached a fishing lure C and the other end of the fishing line is attached to a fishing pole on a boat V (boat not shown to scale). The planer board is attached to and positioned along the fishing line L between the pole and the lure. The fishing line L is connected to the planer board in two places, through the rear swivel attachment 15 and through the rod clip 14. As shown in FIG. 5, the rear swivel attachment 15 is attached to the board via the subring 13 which in turn is connected directly to the board at the split ring hole 11. The rod clip 14 is attached to the board via ring 12. Ring 12 is connected to the rod 9 by being threaded through the rod hole 10 as shown.

### EXAMPLES

### Example 1

In use the front side of the board faces the fishing boat and the back side of the board faces away from the boat. The leading forward end 4 of the planer board points in the same direction as the direction of the boat. The floatation device 8 holds the top long horizontal end 2 of the board above water. The board is attached to the boat by a fishing line that is threaded through the rear swivel 15 and then clipped on to the rod clip 14. There is a port side configuration and a starboard side configuration.

The board is otherwise completely portable.

### Example 2

A method of catching fish is provided wherein the angler attaches the transparent planer board to a fishing line at a location between a fishing lure and a fishing rod on a fishing boat. The angler moves the fishing boat in a forward direction, wherein the transparent planer board is carried laterally away from the moving boat. The fish is attracted to the lure while the transparent nature of the planer board prevents the fish from visually seeing the planer board. The fish bites the lure and the angler catches the fish.

What is claimed is:

1. A transparent planer board comprising:
a transparent main body having a front side, a back side, a top long end, a bottom long end, a forward vertical end and a rear vertical end;
a flotation device attached to the top long end of the planer board and adapted to keep the planer board afloat;
a rod having a first end and a second end, said first end connected to the front side of the planer board, said second end of said rod adapted to connect to a fishing line via a rod clip;
a rear swivel attachment connected to said planer board in the vicinity of the rear end of the planer board, wherein said main body is transparent.

2. The transparent planer board of claim 1, wherein said main body is clear acrylic, acrylic glass or other transparent thermoplastic glass.

3. The transparent planer board of claim 1, wherein the rod is situated closer to the front end of the board, wherein the rod defines a hole at an end of the rod opposite from where it is attached to the main board, and wherein the hole accepts a release mechanism for releasing the fishing line.

4. The transparent planer board of claim 3, wherein said rod is positioned about ⅔ to about ¾ of the distance from the rear end to the front end of the board.

5. The transparent planer board of claim 1, wherein the board is either a port or starboard configuration.

6. The transparent planer board of claim 1, wherein edges of the board on the ends are rolled into smooth edges.

7. The transparent planer board of claim 1, wherein the floatation device is a plank foam having sufficient floatation capability to prevent the transparent planer board from sinking.

8. The transparent planer board of claim 1, wherein the weight of the board is between 2.5 and 5 ounces.

9. A planer board comprising:
a transparent main body and a floatation device attached to an upper end of said transparent main body; said planer board adapted to be connected to a fishing line, said fishing line disposed between a lure and a fishing pole on a moving boat, said planer board capable of carrying said fishing lure laterally away from said moving boat.

10. The transparent planer board of claim 2, wherein the board is colorless.

11. The transparent planer board of claim 10, wherein said main body is clear acrylic, acrylic glass or other transparent thermoplastic glass.

12. The transparent planer board of claim 10, wherein said rod is positioned about ⅔ to about ¾ of the distance from the rear end to the front end of the board.

13. The transparent planer board of claim 10, wherein the board is either a port or starboard configuration.

14. The transparent planer board of claim 10, wherein edges of the board on the ends are rolled into smooth edges.

15. The transparent planer board of claim 10, wherein the floatation device is a plank foam having sufficient floatation capability to prevent the transparent planer board from sinking.

16. The transparent planer board of claim 10, wherein the floatation device is water resistant in hot or cold water and mold proof.

17. The transparent planer board of claim 10, wherein the weight of the board is between 2.5 and 5 ounces.

18. The transparent planer board of claim 10, wherein the board is colorless.

19. A method of catching fish comprising:
attaching the transparent planer board of claim 1 to a fishing line at a location between a fishing lure and a fishing rod on a fishing boat;
moving said fishing boat in a forward direction, wherein said transparent planer board is carried laterally away from said moving boat;
attracting the fish to the lure while preventing the fish from visually seeing the planer board;
and catching said fish.

20. The transparent planer board of claim 19, wherein said main body is clear, colorless acrylic, acrylic glass or other transparent thermoplastic glass.
